(19) United States
(12) Patent Application Publication
(10) Pub. No.: US 2011/0258220 A1
(43) Pub. Date: Oct. 20, 2011

(54) FIXTURE ADMINISTRATION SYSTEM AND ADMINISTRATION METHOD THEREOF

(75) Inventors: LEI LI, Shenzhen (CN); PING CHEN, Shenzhen City (CN); LI-JUN CHEN, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 12/909,954

(22) Filed: Oct. 22, 2010

(30) Foreign Application Priority Data
Apr. 20, 2010 (CN) 201010151337.4

(51) Int. Cl. G06F 17/30

(52) U.S. Cl. 707/769; 707/E17.108

(57) ABSTRACT

A fixture administration system for administrating fixtures with an administration method, the system includes a database, a server, client computers, and a network connecting the client computers, the database and the server. The sever includes a requesting module, a notification module, a recording module, and a processing module. The requesting module starts a design request for the fixtures. The processing module processes the design request to extract and transmit a stored fixture report from the database to the notification module. The notification module notifies to modify the fixtures and create a new fixture report. The recording module records the new fixture report. The processing module compares and replaces the stored fixture report with the new fixture report.

### BACKGROUND

1. Technical Field

The present disclosure relates to a fixture administration system and an administration method thereof.

2. Description of the Related Art

Fixtures are generally important to fix workpieces during manufacturing. Various types of workpieces need various fixtures to match with them. Particularly, when the workpiece is redesigned, the corresponding fixture needs a matching modification. Accordingly, many fixtures need modifications. However, it might be difficult to modify the fixtures.

Therefore, there is room for improvement within the art.

### BRIEF DESCRIPTION OF THE DRAWINGS

Many aspects of the present fixture administration system and administration method can be better understood with reference to the following drawings. The components in the drawings are not necessarily drawn to scale, the emphasis instead being placed upon clearly illustrating the principles of the present fixture administration system and the administration method. Moreover, in the drawings, like reference numerals designate corresponding parts throughout the several views.

FIG. 1 is a schematic view of a framework of a fixture administration system according to an exemplary embodiment.

FIG. 2 is a schematic view of a server of the fixture administration system show in FIG. 1.

FIG. 3 is a flow chart of an administration method corresponding to the fixture administration system show in FIG. 1.

### DETAILED DESCRIPTION

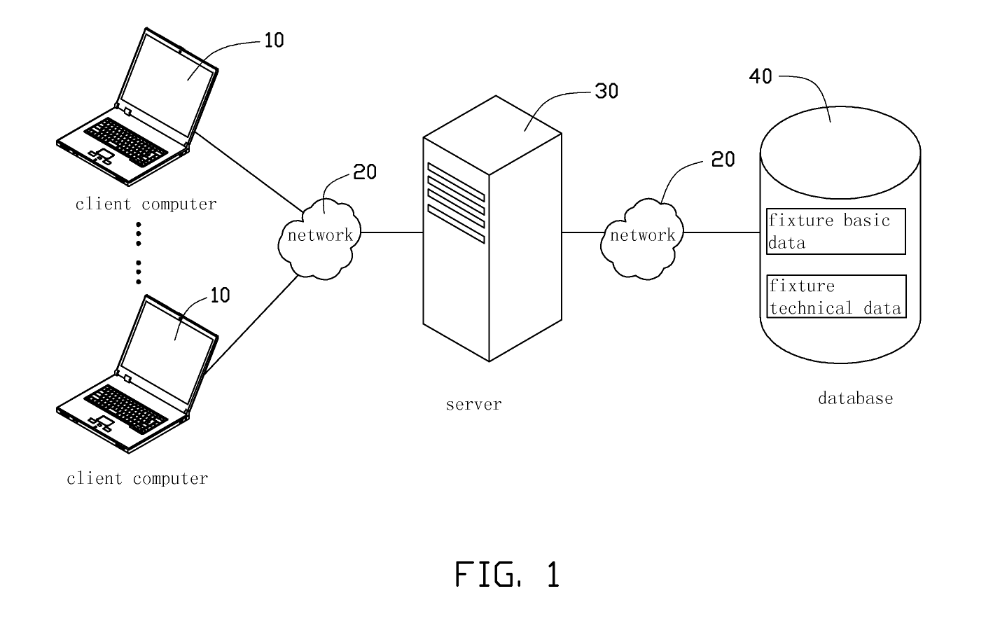

FIG. 1 shows a fixture administration system according to an exemplary embodiment that includes client computers 10, a network 20, a server 30 and a database 40. Fixtures are used for properly positioning and supporting workpieces during manufacturing. The client computers 10 and the database 40 connect to the server 30 through the network 20. The network 20 may be Intranet or Internet. The client computers 10 may have an email system installed. The database 40 stores basic fixture identification data and fixture technical data. The basic fixture identification data includes serial numbers, titles, types, modification records, usage records, identification data, users, storage positions, and administrators. The fixture technical data includes fixture reports corresponding to fixtures. The fixture report can show technical parameters of the fixture such as length, width, standard dimension, and tolerance.

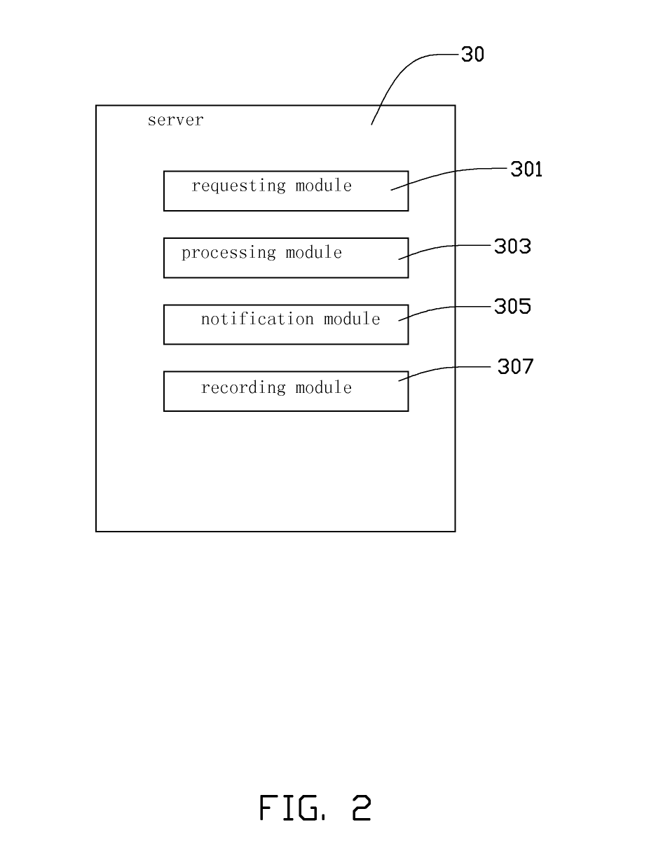

FIG. 2 shows the server 30 including a requesting module 301, a processing module 303, a notification module 305, and a recording module 307. The requesting module 301 can create a request table in which the administrator can input information related to the fixtures such as the serial numbers and comments. The comments may be that particular fixture(s) need to be modified or abandoned. When the information is inputted, the requesting module 301 can transmit the request table to the processing module.

The processing module 303 can process the request table from the requesting module 301. The processing module 303 may search, find and extract the stored fixture report from the database 40 corresponding to the serial numbers listed in the request table. If the stored fixture report cannot be found in the database 40, the input serial number may be not proper. In this case, the processing module 303 can return the request table to the requesting module 301. If the fixture is found in the database 40, the processing module 303 may extract the stored fixture report from database 40 such as the users and the administrators and transmit the fixture report to the notification module 305.

The notification module 305 can send E-mails containing the stored fixture report to the client computers 10 to notify users that certain fixtures need to be modified. The modification to the fixtures may include such things as the redesign of the fixture, and the approval of the fixture design.

When the user modification of the fixtures is finished, a new fixture report is created by the processing module 303. The recording module 307 can record the new fixture report into the database 40. The processing module 303 can compare the new fixture report with the stored fixture report sent by the notification module 305, and determine whether all of the fixtures queued for modification have been modified. The processing module 303 can further replace the stored fixture data with the fixture data of the new fixture report.

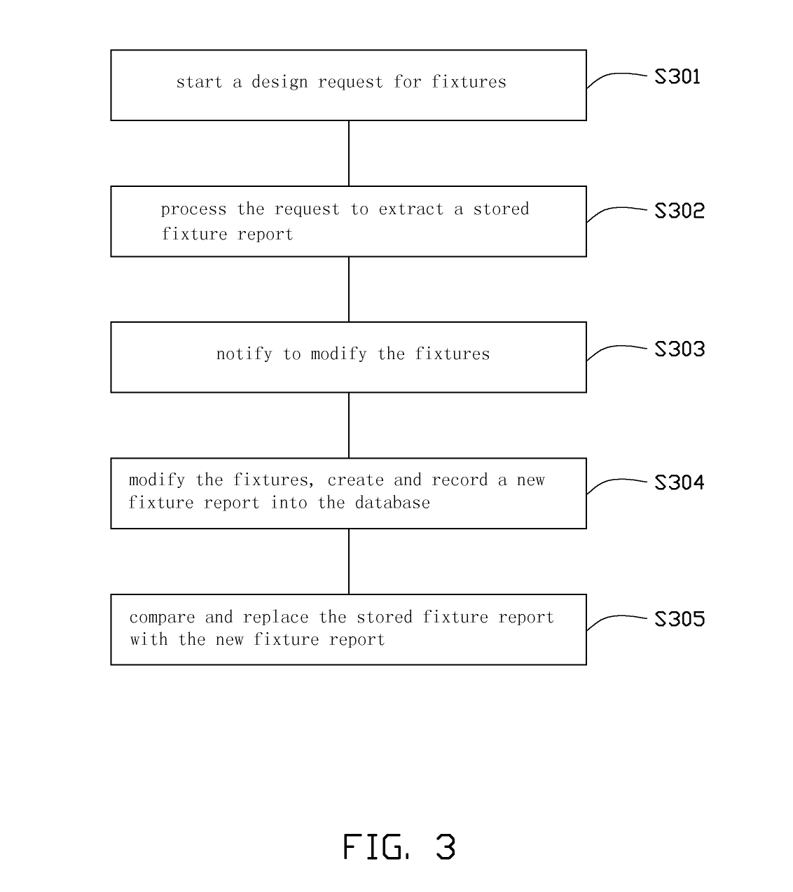

FIG. 3 shows the steps of the administration method for fixtures as follows. S301 is to start a design request for the fixtures. Specifically, the requesting module 301 creates the request table. The administrator inputs information related to the fixture into the request table. When the request table is finished, the requesting module 301 transmits the request table to the processing module 303.

S302 is to process the request. Specifically, the processing module 303 searches, finds, and extracts the stored fixture report of the fixtures from the database 40 according to the serial numbers listed in the request table. When the stored fixture report is extracted, the processing module 303 transmits the stored fixture report to the notification module 305

S303 is to notify users to modify the fixtures. Specifically, the notification module 305 sends E-mails containing the stored fixture report to the client computers 10 to notify users to modify the fixtures.

S304 is to modify the fixtures, create and record a new fixture report into the database 40. Specifically, the recording module 307 can record the new fixture report into the database 40.

S305 is to compare and replace the stored fixture report with the new fixture report. Specifically, the processing module 303 can compare the new fixture report with the stored fixture report, and determine whether all of the fixtures have been modified. If all fixtures have been modified, the processing module 303 can replace the stored fixture data with the fixture data of the new fixture report. If there are unmodified fixtures, S303 through S305 may be repeated until all of the fixtures have been modified.

It is to be understood that even though numerous characteristics and advantages of the present embodiments have been set forth in the foregoing description, together with details of assemblies and functions of various embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A fixture administration system for administrating fixtures, comprising:
a database storing basic fixture identification data and fixture technical data, the fixture technical data includes a stored fixture report;
a server comprising:
a requesting module for starting a design request for the fixtures;
a notification module for notifying users to modify the fixtures and create a new fixture report;
a recording module for recording a new fixture report into the database;
a processing module for processing the design request from the requesting module to extract and transmit the stored fixture report corresponding to the design request to the notification module, the processing module further for comparing and replacing the stored fixture report with the new fixture report;
a plurality of client computers; and
a network connecting the client computers, the database and the server.

2. The fixture administration system as claimed in claim 1, wherein the requesting module is for creating and transmitting a requesting table to the processing module.

3. The fixture administration system as claimed in claim 2, wherein the requesting table includes information related to the fixtures, and the information includes serial numbers of the fixtures or the conclusive comments of the fixtures.

4. The fixture administration system as claimed in claim 2, wherein the processing module is for processing the requesting table to search, find and extract the stored fixture report.

5. The fixture administration system as claimed in claim 4, wherein the requesting table includes serial numbers of the fixtures, the processing module search, find and extract the stored fixture report corresponding to the serial numbers the serial numbers.

6. The fixture administration system as claimed in claim 4, wherein the processing module is for returning the requesting table to the requesting module when the stored fixture report cannot be found to match the requesting table.

7. The fixture administration system as claimed in claim 1, wherein the notification module is for sending E-mails containing the stored fixture report to the client computers.

8. The fixture administration system as claimed in claim 1, wherein the processing module is for determining whether all of the fixtures queued for modification have been modified, and replacing the stored fixture report with the new fixture report when all fixtures have been modified.

9. The fixture administration system as claimed in claim 8, wherein the server is for repeating the notification of notification module, the recording of the recording module, and the comparing of the processing module until the processing module replaces the stored fixture report with the new fixture report.

10. A fixture administration method for administrating fixtures, comprising:
providing a fixture administration system comprising a database, a server, a plurality of client computers, and a network connecting the client computers, the database and the server, the database storing basic fixture identification data and fixture technical data, the fixture technical data including a stored fixture report;
providing the server with a requesting module, a notification module, a recording module, and a processing module;
starting a design request for the fixtures by the requesting module;
processing the design request from the requesting module to extract and transmit the stored fixture report corresponding to the design request to the notification module by the processing module;
notifying to modify the fixtures and create a new fixture report by the notification module;
recording the new fixture report into the database by the recording module;
comparing and replacing the stored fixture report with the new fixture report by the processing module.

11. The fixture administration method as claimed in claim 10, wherein during starting the design request, the requesting module creates and transmits a requesting table to the processing module.

12. The fixture administration method as claimed in claim 11, wherein the requesting table includes information related to the fixtures, and the information includes serial numbers of the fixtures or the conclusive comments of the fixtures.

13. The fixture administration method as claimed in claim 11, wherein the processing module is for processing the requesting table to search, find and extract the stored fixture report.

14. The fixture administration method as claimed in claim 13, wherein the requesting table includes serial numbers of the fixtures, the processing module searching, finding and extracting the stored fixture report corresponding to the serial numbers the serial numbers.

15. The fixture administration method as claimed in claim 13, wherein if the stored fixture report cannot be found to match the requesting table, the processing module returns the requesting table to the requesting module.

16. The fixture administration method as claimed in claim 10, wherein during notification, the notification module sends E-mails containing the stored fixture report to the client computers.

17. The fixture administration method as claimed in claim 10, wherein during comparing, the processing module determines whether all of the fixtures queued for modification have been modified, if all fixtures have been modified, the processing module replaces the stored fixture report with the new fixture report.

18. The fixture administration method as claimed in claim 17, wherein if there are fixtures unmodified, repeats the notification of notification module, the recording of the recording module, and the comparing of the processing module until the processing module replaces the stored fixture report with the new fixture report.
